(19) United States
(12) Patent Application Publication
(10) Pub. No.: US 2020/0147733 A1
(43) Pub. Date: May 14, 2020

(54) LOW MANGANESE EMITTING WELDING FLUX

(71) Applicant: ZIKA INDUSTRIES LTD., Acre (IL)

(72) Inventor: Kiril KIRIYEVSKY, Nesher (IL)

(21) Appl. No.: 16/631,068

(22) PCT Filed: Jul. 19, 2018
(86) PCT No.: PCT/IL2018/050804

§ 371 Date: Jan. 14, 2020

Related U.S. Application Data
(60) Provisional application No. 62/612,601, filed on Dec. 31, 2017.
(60) Provisional application No. 62/683,712, filed on Jun. 12, 2018.

(30) Foreign Application Priority Data
Jul. 20, 2017 (IL) 253605

(51) Int. Cl. B23K 35/362; B23K 35/36; B23K 9/04; B23K 101/32

(52) U.S. Cl. CPC B23K 35/362; B23K 2101/32; B23K 9/048; B23K 35/3612

(57) ABSTRACT

A composition comprised of manganese or a compound thereof, a cellulosic material, a carbonate, titanium, and one or more from: an alloying agent, a slag-forming agent, an arc-stabilizing agent, wherein the cellulosic material is present at a concentration of 1% to 40%, by weight, and wherein the manganese or a compound thereof is present at a concentration of 0.5 to 5%, by weight, is disclosed. A method of depositing a weld metal on a surface is further disclosed.

### CROSS-REFERENCE TO RELATED APPLICATIONS

This application claims the benefit of priority from: Israel Patent Application No. 253605, filed on Jul. 20, 2017; and U.S. Provisional Patent Application Nos. 62/612,601, filed on Dec. 31, 2017, and 62/683,712 filed on Jun. 12, 2018. The contents of the above documents are incorporated by reference in their entirety as if fully set forth herein.

### FIELD OF INVENTION

The present invention, inter alia, is in the field of welding electrodes having low manganese content.

### BACKGROUND OF THE INVENTION

Manganese is a very important and essential alloying element in steel. Together with carbon, manganese is responsible for hardness, toughness and strength of steel, as well as significant improvement of steel plasticity. During arc welding processes, manganese is transferred from the consumable electrode to the weld metal, a process that is typically accompanied by manganese vapor emission. Therefore, evaporated manganese compounds exist in the work area of a welder in a relatively high concentration.

Prolonged inhalation of manganese compounds by a welder has been found to be harmful. Reducing manganese content in the welding consumable electrode leads to reduced manganese content in the weld metal and, hence, to reduced mechanical properties of the weld metal. There is a need for a low content manganese electrode which yet fulfils the required mechanical properties for the weld metal.

### SUMMARY OF THE INVENTION

The present invention, inter alia, relates to welding electrodes having low manganese content.

According to an aspect of some embodiments of the present invention there is provided a composition comprising manganese or a compound thereof, a cellulosic material, a carbonate, titanium, and at least one member selected from the group consisting of: an alloying agent, a slag-forming agent, an arc-stabilizing agent, and any combination thereof, wherein the cellulosic material is present at a concentration of 1% to 40%, by weight, and wherein the manganese or a compound thereof is present at a concentration of 0.5 to 5%, by weight.

In some embodiments, the carbonate comprises calcium carbonate.

In some embodiments, the composition further comprises fluorite.

In some embodiments, the composition further comprises boron, or any combination thereof.

In some embodiments, the composition further comprises nickel at a concentration of less than 1%, by weight. In some embodiments, the composition is devoid of nickel.

In some embodiments, the composition comprises cellulosic material, a compound comprising boron, nickel, or any combination thereof. In some embodiments, the boron compound is selected from: boric acid and borax.

In some embodiments, the weight content of the boron is in the range of 0.004-0.2%. In some embodiments, the weight content of the nickel is in the range of 0.1-0.2%.

In some embodiments, the cellulosic material is present at a concentration of 20 to 40%, by weight.

In some embodiments, the cellulosic material is selected from the group consisting of: sodium carboxyl methyl cellulose, hydroxyl ethyl cellulose, and a combination thereof.

In some embodiments, the composition further comprises a deoxidizer. In some embodiments, the deoxidizer comprises a material selected from the group consisting of chromium oxide, ferroalloy material, and a combination thereof.

In some embodiments, the deoxidizer comprises a material selected from the group consisting of ferrosilicon, ferrotitanium, zircon, and a combination thereof.

In some embodiments, the ferroalloy material comprises ferromanganese. In some embodiments, the slag-forming agent is selected from the group consisting of: quartz, titania, metal carbonate, alumosilicate, and any combination thereof. In some embodiments, the titania is in the form of rutile. In some embodiments, the alloying agent comprises a material selected from the group consisting of: ferromanganese, boric acid, nickel, and any combination thereof.

In some embodiments, the arc-stabilizing agent comprises a material selected from the group consisting of: titania, metal carbonate, potassium titanate, and any combination thereof.

In some embodiments, the arc-stabilizing agent comprises iron.

In some embodiments, the metal carbonate comprises one or more materials selected from: sodium carbonate, magnesium carbonate, calcium carbonate, or any combination thereof.

In some embodiments, the metal carbonate is in the form of dolomite.

In some embodiments, the dolomite is present at a concentration in the range of from 8% to 16%.

In some embodiments, the manganese comprises ferromanganese.

In some embodiments, the deoxidizer is present at a concentration of 4 to 10%, by total weight. In some embodiments, the deoxidizer is present at a concentration of 10 to 18%, by total weight.

In some embodiments, the carbonate is present at a concentration of 15 to 40%, by total weight. In some embodiments, the carbonate is present at a concentration of 15 to 22%, by total weight. In some embodiments, the carbonate is present at a concentration of 25 to 35%, by total weight.

In some embodiments, the arc stabilizer is present at a concentration of 15 to 35%, by total weight.

In some embodiments, the alloying element is present at a concentration of 2 to 7%, by total weight. In some embodiments, the alloying element is present at a concentration of 2 to 7%, by total weight.

In some embodiments, slag-forming agent is present at a concentration of 35 to 55%, by total weight. In some embodiments, the slag-forming agent is present at a concentration of 4 to 8%, by total weight.

In some embodiments, the composition further comprises nanosized zirconia.

In some embodiments, the composition is in the form of a coating on a substrate.

In some embodiments, the substrate comprises one or more metals.

According to another aspect, there is provided an article comprising a metal wire, and the composition described herein in the form of a coating on the metal wire.

In some embodiments, the article is a tubular welding wire.

In some embodiments, the tubular welding wire is characterized by a diameter of a core metal wire in the range of 1.5 to 6 mm. In some embodiments, the welding wire is characterized by a diameter of a core metal wire in the range of 4 to 6 mm. In some embodiments, the welding wire is characterized by a diameter of a core metal wire in the range of 3.3 or less.

In some embodiments, the coating is in the form of a welding flux.

In some embodiments, the article is a shielded arc electrode. In some embodiments, the shielded arc electrode is a welding consumable.

In some embodiments, the electrode is configured to form a weld metal on a steel workpiece, wherein the weld metal comprises less than 0.3 wt % nickel.

According to another aspect, there is provided a method of depositing a weld metal on a surface, comprising the steps of: (a) advancing a welding consumable toward a metal-alloy workpiece, wherein the welding consumable comprises the disclosed composition in an embodiment thereof and (b) establishing an arc between a welding electrode and the metal-alloy workpiece so as to melt a portion of the welding consumable and a portion of the metal-alloy workpiece. In some embodiments, the metal-alloy is a steel alloy. In some embodiments, the weld metal is characterized by ductility of 20-35 wt % elongation as compared to the original material length. In some embodiments, the weld metal is characterized by an averaged V-Charpy impact energy of 110-150 J at −30° C. In some embodiments, the weld metal comprises up to 0.3 wt % nickel. In some embodiments, the weld metal comprises up to 0.08 wt % ferro vanadium. In some embodiments, the weld metal comprises up to 0.2 wt % chromium. In some embodiments, the weld metal comprises 0.20-0.22 wt % silicon.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### DETAILED DESCRIPTION OF THE INVENTION

Electrode Coatings

According to some embodiments of the present invention, there is provided a composition having a low manganese weight content comprising: manganese or any compound thereof, a carbonate, and one or more agent selected from an alloying agent, an arc-stabilizing agent, a slag-forming agent, a deoxidizer (also referred to as “deoxidizing compound”), or any combination thereof.

In some embodiments, the composition is for use in welding electrodes. In some embodiments, the composition further comprises a halide mineral.

In some embodiments, the composition disclosed herein, in any embodiment thereof, is characterized by low manganese weight content. In some embodiments, by “low manganese weight content” it is meant to refer to less than 7%, less than 6%, less than 5%, less than 4%, less than 3%, less than 2%, or less than 1% manganese, by weight of the composition.

In some embodiments, by “by weight”, it is meant to refer to the total weight of the dry mix.

In some embodiments, the manganese content is in the range of 1% to 7%, by weight. In some embodiments, the manganese content is in the range of 1.5% to 7%, by weight. In some embodiments, the manganese content is in the range of 1.5% to 6%, by weight. In some embodiments, the manganese content is in the range of 2% to 5%, by weight. In some embodiments, the manganese content is in the range of 2% to 4%, by weight. In some embodiments, the manganese content is in the range of 2.5% to 3%, by weight.

In some embodiments, the manganese content is 1%, 1.5%, 2%, 2.5%, 3%, 3.5%, 4%, 4.5%, 5%, 5.5%, 6%, 6.5%, or 7%, including any value and range therebetween. In some embodiments, the manganese weight content is about 4.8%.

In some embodiments, the manganese comprises a ferromanganese compound.

In some embodiments, ferromanganese compound weight content is in the range of 3% to 9%. In some embodiments, ferromanganese compound weight content is in the range of 5% to 7%. In some embodiments, the ferromanganese compound weight content is 5%, 5.1%, 5.2%, 5.3%, 5.4%, 5.5%, 5.6%, 5.7%, 5.8%, 5.9%, 6%, 6.1%, 6.2%, 6.3%, 6.4%, 6.5%, 6.6%, 6.7%, 6.8%, 6.9%, or 7%, including any value and range therebetween. In some embodiments, the ferromanganese compound weight content is about 6%.

The term “ferromanganese” refers to a ferroalloy with high content of manganese. Non-limiting examples for providing ferromanganese is by heating a mixture of the oxides MnO₂ and Fe₂O₃, with carbon.

In some embodiments, the composition further comprises an arc-stabilizing agent. In some embodiments, the composition further comprises a slag-forming agent. In some embodiments, the composition further comprises a slipping agent. In some embodiments, the composition further comprises a deoxidizer. In some embodiments, the composition further comprises a combination of two or more agents selected from: an alloying agent, an arc-stabilizing agent, a slag-forming agent, a deoxidizer, and a slipping agent.

Exemplary deoxidizers are selected from, without being limited thereto, metal oxide and ferroalloy material.

In some embodiments, the deoxidizer comprises a material selected from, without limitation, chromium oxide, ferroalloy material, and a combination thereof.

In some embodiments, the term “ferroalloy” as used herein is meant to refer to an alloy which contains e.g., at least 1%, at least 5%, at least 10%, at least 20%, or at least 30%, iron, by weight.

In some embodiments, the ferroalloy comprises ferrosilicon. In some embodiments, the ferroalloy comprises ferrotitanium. In some embodiments, the ferroalloy comprises ferro-vanadium. In some embodiments, the ferroalloy comprises ferromanganese.

In some embodiments, the deoxidizer comprises a material selected from, without being limited thereto, ferrosilicon, ferrotitanium, zircon, and any combination thereof.

By “zircon” it is also meant to encompass zirconium, or zirconium oxide.

In some embodiments, the deoxidizer comprises a material selected from, without being limited thereto, magnesium powder, aluminum-zirconium powder, ferro-zirconium-silicon powder, aluminum-magnesium powder, aluminum powder, ferro-silicon powder, calcium silicon powder, or any combination thereof.

In some embodiments, the deoxidizer is present at a concentration of 2% to 15%, by weight. In some embodiments, the deoxidizer is present at a concentration of 2% to 12%, by weight. In some embodiments, the deoxidizer is present at a concentration of 4% to 12%, by weight. In some embodiments, the deoxidizer is present at a concentration of 4% to 10%, by weight. In some embodiments, the deoxidizer is present at a concentration of 10% to 20%, by weight. In some embodiments, the deoxidizer is present at a concentration of 10% to 18%, by weight.

In some embodiments, the deoxidizer is present at a concentration of 2%, 3%, 4%, 5%, 6%, 7%, 8%, 9%, 10%, 11%, 12%, 13%, 14%, or 15%, by weight, including any value and range therebetween.

In some embodiments, the metal oxide is chromium oxide.

In some embodiments, the composition comprises boron or a compound thereof.

In some embodiments, the composition comprises a shielding-gas generator compound. In some embodiments, the shielding-gas generator compound is selected from, without being limited thereto, carbonate metal salts, cellulosic material (e.g., hydroxyl ethyl cellulose), sodium carboxymethyl cellulose, or any combination thereof.

In some embodiments, the composition comprises a slipping agent. In some embodiments, the slipping agent comprises a cellulosic material. In some embodiments, the slipping agent comprises a one or more members selected from, without being limited thereto, talc (e.g., 3MgO₄SiO₂4H₂O) and clays (e.g., Al₂O₃2SiO₂2H₂O).

In some embodiments, the slipping agent (e.g., cellulosic material) is present in weight content in the range of from 0.1% to 5%. In some embodiments, the slipping agent weight content is in the range of from 0.2% to 5%. In some embodiments, the slipping agent weight content is in the range of from 0.3% to 4%. In some embodiments, the slipping agent weight content is 0.1%, 0.2%, 0.4%, 0.6%, 0.8%, 1%, 1.2%, 1.4%, 1.6%, 1.8%, 2%, 2.2%, 2.4%, 2.6%, 2.8%, 3%, 3.2%, 3.4%, 3.6%, 3.8%, 4%, 4.2%, 4.4%, 4.6%, 4.8%, or 5%, including any value and range therebetween.

In some embodiments, the composition comprises a cellulosic material.

In some embodiments, the cellulosic material comprises hydroxyl ethyl cellulose. In some embodiments, the cellulosic material comprises carboxyl methyl cellulose, e.g., sodium carboxyl methyl cellulose.

In some embodiments, the cellulosic material is present in a weight content in the range of from 20% to 40%. In some embodiments, the cellulosic material is present in the range of from 1% to 14%, by weight. In some embodiments, the cellulosic material is present in the range of from 1% to 40%, by weight. In some embodiments, the cellulosic material is present in the range of from 1% to 34%, by weight.

In some embodiments, the cellulosic material is present in the range of from 2% to 10%, by weight. In some embodiments, the cellulosic material is present in the range of from 4% to 8%, by weight. In some embodiments, the cellulosic material is present at a concentration of 4%, 4.2%, 4.4%, 4.6%, 4.8%, 5%, 5.2%, 5.4%, 5.6%, 5.8%, 6%, 6.2%, 6.4%, 6.6%, 6.8%, 7%, 7.2%, 7.4%, 7.6%, 7.8%, or 8%, by weight, including any value and range therebetween. In some embodiments, the cellulosic material weight content is about 6.7%.

In some embodiments, the cellulosic material is present in the range of from 20% to 35%. In some embodiments, the cellulosic material is present in the range of from 30% to 40%. In some embodiments, the cellulosic material weight content is 20%, 22%, 24%, 26%, 28%, 30%, 32%, 34%, 36%, 38%, or 40%, including any value and range therebetween.

In some embodiments, the composition comprises Na-cmc. In some embodiments, Na-cmc weight content is in the range of from 0.02% to 2%. In some embodiments, Na-cmc weight content is in the range of from 0.05% to 1%. In some embodiments, Na-cmc weight content is in the range of from 0.1% to 0.3%. In some embodiments, the Na-cmc weight content is 0.1%, 0.12%, 0.14%, 0.16%, 0.18%, 0.2%, 0.22%, 0.24%, 0.26%, 0.28%, or 0.3%, including any value and range therebetween. In some embodiments, the Na-cmc weight content is about 0.2%.

The term “Na-cmc” refers herein to a sodium salt of carboxymethyl cellulose; a cellulose derivative with carboxymethyl groups bound to some of the hydroxyl groups of the glucopyranose monomers that make up the cellulose backbone.

In some embodiments, the composition comprises carbonate.

In some embodiments, the composition comprises a metal carbonate compound. In some embodiments, the metal in the metal carbonate compound is selected from, without being limited thereto, calcium, magnesium, or any combination thereof. In some embodiments, the metal carbonate is in the form of a dolomite.

In some embodiments, the term “dolomite” refers to an anhydrous carbonate mineral composed of calcium magnesium carbonate, including, but not limited to, CaMg(CO₃)₂.

In some embodiments, the carbonate weight content is at least 10%, or at least 15%. In some embodiments, the carbonate weight content is in the range of from 15% to 40%. In some embodiments, the carbonate weight content is in the range of from 20% to 35%. In some embodiments, the carbonate weight content is in the range of from 25% to 35%. In some embodiments, the carbonate weight content is in the range of from 25% to 30%.

In some embodiments, the carbonate weight content is 15%, 16%, 17%, 18%, 19%, 20%, 21%, 22%, 23%, 24%, 25%, 26%, 27%, 28%, 29%, 30%, 31%, 32%, 33%, 34%, or 35%, including any value and range therebetween.

In some embodiments, the dolomite weight content is at least 8% or at least 8.1%. In some embodiments, the dolomite weight content is in the range of from 8% to 16%. In some embodiments, the dolomite weight content is in the range of from 10% to 14%. In some embodiments, the dolomite weight content is in the range of from 12% to 14%. In some embodiments, the dolomite weight content is 12%, 12.1%, 12.2%, 12.3%, 12.4%, 12.5%, 12.6%, 12.7%, 12.8%, 12.9%, 13%, 13.1%, 13.2%, 13.3%, 13.4%, 13.5%, 13.6%, 13.7%, 13.8%, 13.9%, or 14%, including any value and range therebetween. In some embodiments, the dolomite weight content is about 14%.

In some embodiments, the term “slag”, or any grammatical derivative thereof, is intended to mean a partially or entirely vitreous product that may be added to and optionally removed from a metal liquid product. Further, the term “slag forming agent” is intended to mean a compound or a product used to form slag.

In some embodiments, the slag-forming compound is selected from, without being limited thereto, rutile, manganous oxide, or any combination thereof.

In some embodiments, the slag-forming agent comprises quartz. In some embodiments, the slag-forming agent comprises calcium aluminate. In some embodiments, the slag forming agent comprises titania. In some embodiments, the titania is in the form of rutile. In some embodiments, the slag-forming agent comprises metal carbonate. In some embodiments, the slag-forming agent comprises alumosilicate.

In some embodiments, the slag-forming agent is present at a concentration of 2% to 10%, by weight. In some embodiments, the slag-forming agent is present at a concentration of 4% to 8%, by weight. In some embodiments, the slag-forming agent is present at a concentration of 2%, 3%, 4%, 5%, 6%, 7%, 8%, 9%, or 10%, by weight, including any value and range therebetween.

In some embodiments, the slag-forming agent is present at a concentration of 5% to 25%, by weight. In some embodiments, the slag-forming agent is present at a concentration of 8% to 18%, by weight. In some embodiments, the slag-forming agent is present at a concentration of 5%, 6%, 7%, 8%, 9%, 10%, 11%, 12%, 13%, 14%, 15%, 16%, 17%, 18%, 19%, 20%, 21%, 22%, 23%, 24%, or 25%, by weight, including any value and range therebetween.

In some embodiments, the slag-forming agent is present at a concentration of 30% to 60%, by weight. In some embodiments, the slag-forming agent is present at a concentration of 35% to 55%, by weight. In some embodiments, the slag-forming agent is present at a concentration of 30%, 35%, 40%, 45%, 50%, 55%, or 60%, by weight, including any value and range therebetween.

In some embodiments, the halide mineral comprises a fluorite.

In some embodiments, the halide mineral is present at a concentration of 20% to 35%, by weight. In some embodiments, the halide mineral is present at a concentration of 20% to 30%, by weight. In some embodiments, the halide mineral is present at a concentration of 25% to 30%, by weight. In some embodiments, the halide mineral is present at a concentration of 20%, 21%, 22%, 23%, 24%, 25%, 26%, 27%, 28%, 29%, 30%, 31%, 32%, 33%, 34%, or 35%, including any value and range therebetween.

As described hereinabove, in some embodiments, the composition comprises a boron compound.

In some embodiments, the boron compound is selected from, without being limited thereto, boric acid, lithium tetraborat, and borax. In some embodiments, the composition comprises boric acid. In some embodiments, the composition comprises borax.

In some embodiments, the composition comprises boron in a weight content in the range of 0.004% to 2%. In some embodiments, the composition comprises boron in a weight content in the range of 0.1% to 2%. In some embodiments, the composition comprises boron in a weight content in the range of 0.2% to 2%. In some embodiments, the composition comprises boron in a weight content in the range of 0.5% to 1.5%. In some embodiments, the boron weight content is in the range of 0.5% to 1.5%. In some embodiments, the boron weight content is 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, or 2%, including any value and range therebetween.

In some embodiments, the composition comprises iron. In some embodiments, the iron is in the form of a powder. In some embodiments, the iron weight content is in the range of from 1% to 30%. In some embodiments, the iron weight content is in the range of from 5% to 25%. In some embodiments, the iron weight content is in the range of from 10% to 20%. In some embodiments, the iron weight content is 10%, 11%, 12%, 13%, 14%, 15%, 16%, 17%, 18%, 19%, or 20%, including any value and range therebetween. In some embodiments, the iron is in the form of a powder. In some embodiments, the iron powder weight content is about 14.2%.

In some embodiments, the composition comprises nickel.

In some embodiments, the nickel weight content is in the range of from 0.05% to 3%.

In some embodiments, the nickel weight content is in the range of from 0.05% to 2%. In some embodiments, the nickel weight content is in the range of 0.1% to 2%. In some embodiments, the nickel weight content is in the range of from 0.05% to 2%. In some embodiments, nickel weight content is in the range of 0.1% to 1.5%. In some embodiments, the nickel weight content is in the range of 0.1% to 1%. In some embodiments, the nickel weight content is in the range of 0.1% to 0.5%. In some embodiments, the nickel weight content is in the range of 0.1% to 0.4%.

In some embodiments, the nickel weight content is 0.05%, 0.1%, 0.15%, 0.2%, 0.25%, 0.3%, 0.35%, 0.4%, 0.45%, or 0.5%, including any value and range therebetween.

In some embodiments, the nickel weight content is less than 0.05%, less than 0.1%, less than 0.15%, less than 0.2%, less than 0.25%, less than 0.3%, less than 0.35%, less than 0.4%, less than 0.45%, or less than 0.5%.

In some embodiments, the nickel weight content is 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, or 2%, including any value and range therebetween. In some embodiments, the nickel weight content is about 0.75%. In some embodiments, the nickel is in the form of a nickel powder.

In some embodiments, the boron to manganese weight ratio in the composition described herein is 1:1, 1:2, 1:3, 1:4, 1:5, 1:6, 1:7, 1:8, 1:9, or 1:10, including any value and range therebetween. In some embodiments, the boron to manganese weight ratio is 1:2 to 1:4. In some embodiments, the boron to manganese weight ratio is about 1:2.7.

In some embodiments, the boron to manganese weight ratio in the composition described herein is 1:50, 1:40, 1:30, 1:20, or 1:10, including any value and range therebetween. In some embodiments, the boron to manganese weight ratio is between 1:20 to 1:40. In some embodiments, the boron to manganese weight ratio is about 1:32.

In some embodiments, the nickel to manganese weight ratio in the composition described herein is 1:20, 1:10, 1:5, or 1:2, respectively, including any value and range therebetween. In some embodiments, the nickel to manganese weight ratio is 1:4 to 1:10. In some embodiments, the nickel to manganese weight ratio is about 1:9.

In some embodiments, the boron to nickel weight ratio in the composition described herein is 1:20, 1:10, 1:7, 1:4 or 1:2, respectively, including any value and range therebetween. In some embodiments, the boron to manganese weight ratio is 1:2 to 1:8, respectively. In some embodiments, the boron to manganese weight ratio is about 1:5, respectively.

In some embodiments, the boron to nickel to manganese weight ratio in the composition described herein is 1:0.1:2, 1:0.3:3, 1:0.4:4, or 1:0.5:5, respectively, including any value and range therebetween.

In some embodiments, the boron to nickel to manganese weight ratio in the composition described herein is 1:2:32, 1:4:32, 1:10:32, 1:2:20, 1:2:40, 1:4:40, 1:6:40, 1:4:20, or 1:5:15, including any value and range therebetween. In some embodiments, the boron to nickel to manganese weight ratio is about 1:5:32.

In some embodiments, the manganese to carbonate weight ratio in the composition described herein is 1:8, 1:9, 1:10, 1:11, or 1:12, respectively, including any value and range therebetween. In some embodiments, the manganese to carbonate weight ratio is from 1:8 to 1:12, respectively. In some embodiments, the manganese to carbonate weight ratio is about 1:10, respectively.

In some embodiments, the nickel to carbonate weight ratio in the composition described herein is 1:50, 1:70, 1:90, 1:100, 1:110, 1:120, or 1:130, respectively, including any value and range therebetween. In some embodiments, the nickel to carbonate weight ratio is from 1:90 to 1:110, respectively.

In some embodiments, the nickel to dolomite weight ratio in the composition described herein is 1:2, 1:4, 1:8, 1:10, 1:14, 1:18, 1:20, 1:24, or 1:30, including any value and range therebetween. In some embodiments, the nickel to dolomite weight ratio is between 1:10 to 1:25. In some embodiments, the nickel to dolomite weight ratio is about 1:18.

In some embodiments, the boron to carbonate weight ratio in the composition described herein is 1:10, 1:20, 1:30, 1:40, 1:50, or 1:60, respectively, including any value and range therebetween. In some embodiments, the boron to carbonate weight ratio is between 1:20 to 1:40, respectively.

In some embodiments, the nickel to manganese to carbonate weight ratio in the composition described herein is 1:8:80, 1:8:90, 1:8:100, 1:8:110, 1:9:80, 1:9:90, or 1:9:100, respectively, including any value and range therebetween.

In some embodiments, the nickel to manganese to dolomite weight ratio in the composition described herein is 1:2:18, 1:5:18, 1:10:18, 1:20:18, 1:2:1, 1:2:2, 1:2:5, 1:2:10, 1:2:15, 1:2:20, 1:5:5, 1:5:10, or 1:10:10, including any value and range therebetween. In some embodiments, the nickel to manganese to dolomite weight ratio is about 1:6.4:18.

In some embodiments, the manganese to dolomite weight ratio in the composition described herein is 1:1, 1:2, 1:3, 1:4, 1:5, 2:1, or 3:1, including any value and range therebetween. In some embodiments, the manganese to dolomite weight ratio is between 1:1 to 1:5 or 1:2 to 1:4. In some embodiments, the manganese to dolomite weight ratio is about 1:3.

In some embodiments, the boron to dolomite weight ratio in the composition described herein is 1:10, 1:20, 1:40, 1:60, 1:80, or 1:100, including any value and range therebetween. In some embodiments, the boron to dolomite weight ratio is between 1:80 to 1:100. In some embodiments, the boron to dolomite weight ratio is about 1:90.

In some embodiments, the boron to manganese to carbonate weight ratio in the composition described herein is 1:2:20, 1:2:30, 1:3:30, 1:2:30, 1:2:40, or 1:3:40, respectively, including any value and range therebetween.

In some embodiments, the boron to manganese to dolomite weight ratio in the composition described herein is 1:10:90, 1:20:90, 1:30:90, 1:40:90, 1:50:90, 1:10:5, 1:10:10, 1:10:20, 1:10:30, 1:10:40, 1:20:10, 1:20:50, or 1:32:70, including any value and range therebetween. In some embodiments, the boron to manganese to dolomite weight ratio is about 1:32:90.

In some embodiments, the nickel to boron to carbonate (e.g., dolomite) weight ratio in the composition described herein is 1:2:100, 1:3:100, 1:3:90, 1:3:80, 1:4:100, 1:4:90, 1:4:90, 1:3:80, 1:3:70, 1:5:100, 1:5:90, 1:5:80, 1:5:70, 1:5:60, or 1:5:50, respectively, including any value and range therebetween. In some embodiments, the nickel to boron to dolomite weight ratio is about 1:3:100, respectively.

In some embodiments, the nickel to boron to manganese to carbonate (e.g., dolomite) weight ratio in the composition described herein is 1:2:10:100, 1:3:10:100, 1:3:10:90, 1:3:10:80, 1:4:10:100, 1:4:10:90, 1:4:10:90, 1:3:10:80, 1:3:10:70, 1:5:10:100, 1:5:10:90, 1:5:10:80, 1:5:10:70, 1:5:10:60, 1:5:10:50, 1:2:12:100, 1:3:12:100, 1:3:12:90, 1:3:12:80, 1:4:12:100, 1:4:12:90, 1:4:12:90, 1:3:12:80, 1:3:12:70, 1:5:12:100, 1:5:12:90, 1:5:12:80, 1:5:12:70, 1:5:12:60, 1:5:12:50, 1:2:11:100, 1:3:11:100, 1:3:11:90, 1:3:11:80, 1:4:11:100, 1:4:11:90, 1:4:11:90, 1:3:11:80, 1:3:11:70, 1:5:11:100, 1:5:11:90, 1:5:11:80, 1:5:11:70, 1:5:11:60, 1:5:11:50, 1:2:9:100, 1:3:9:100, 1:3:9:90, 1:3:9:80, 1:4:9:100, 1:4:9:90, 1:4:9:90, 1:3:9:80, 1:3:9:70, 1:5:9:100, 1:5:9:90, 1:5:9:80, 1:5:9:70, 1:5:9:60, 1:5:9:50, 1:2:8:100, 1:3:8:100, 1:3:8:90, 1:3:8:80, 1:4:8:100, 1:4:8:90, 1:4:8:90, 1:3:8:80, 1:3:8:70, 1:5:8:100, 1:5:8:90, 1:5:8:80, 1:5:8:70, 1:5:8:60, or 1:5:8:50, respectively, including any value and range therebetween.

In some embodiments, the boron to nickel to manganese to dolomite weight ratio in the composition described herein is 1:2:32:90, 1:4:32:90, 1:6:32:90, 1:8:32:90, 1:10:32:90, 1:5:20:90, 1:5:25:90, 1:5:30:90, 1:5:35:90, 1:5:40:90, 1:5:32:20, 1:5:32:30, 1:5:32:40, 1:5:32:50, 1:5:32:60, 1:5:32:70, 1:5:32:80, 1:5:32:100, 1:4:30:30, 1:4:40:40, 1:4:20:20, 1:6:20:20, 1:6:30:30, 1:6:40:40, 1:7:20:20, 1:7:30:30, 1:7:40:40, 1:7:32:40, 1:7:32:50, 1:7:32:60, 1:7:32:70, 1:7:32:80, 1:7:32:90, 1:8:32:40, 1:8:32:50, 1:8:32:60, 1:8:32:70, 1:8:32:80, 1:8:32:90, 1:5:20:30, 1:5:20:40, 1:5:20:50, 1:5:20:60, 1:5:20:70, 1:5:20:80, 1:5:20:90, 1:5:26:90, 1:5:27:90, 1:5:28:90, 1:5:29:90, 1:5:31:90, 1:5:33:90, 1:5:34:90, 1:5:36:90, 1:5:37:90, 1:5:38:90, or 1:5:39:90, respectively, including any value and range therebetween. In some embodiments, the boron to nickel to manganese to dolomite weight ratio is about 1:5:32:90.

In some embodiments, the composition comprises an alloying element (also referred to as: “alloying agent”). In some embodiments, the alloying element is selected from, without being limited thereto, iron, molybdenum, nickel, copper, chromium, manganese, ferromanganese, boric acid, nickel, or any combination thereof. In some embodiments, the nickel is in the form of a nickel powder.

In some embodiments, the alloying agent is present at a concentration of 1% to 10%, 3 to 6%, 2% to 7%, or 5 to 7%. In some embodiments, the alloying agent is present at a concentration of 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10%, including any value and range therebetween.

In some embodiments, the alloying element comprises microalloying element. In some embodiments, the microalloying element is selected from, without being limited thereto, aluminum, vanadium, niobium, boron, manganese and titanium, or any combination thereof.

The phrase “microalloying element” may refer to an element introduced in a small quantity (typically, but not exclusively, at ppm levels) to weld metal via electrode core wire or via the flux ingredients, to affect the microstructure and properties of the weld metal.

In some embodiments, the composition comprises a shielding-gas generator compound. In some embodiments, the shielding-gas generator compound is selected from, without being limited thereto, carbonate metal salts, cellulose, and sodium carboxymethyl cellulose, or any combination thereof.

In some embodiments, the composition comprises an arc-stabilizing compound. In some embodiments, the arc-stabilizing compound is selected from, without being limited thereto, iron oxide, titania, metal carbonate, potassium fluorosilicate, potassium titanate, sodium titanate, lithium oxide, or any combination thereof. In some embodiments, the arc-stabilizing agent (e.g., compound) comprises iron. In some embodiments, the metal carbonate comprises sodium carbonate.

In some embodiments, the arc-stabilizing agent is present at a concentration of 10% to 40%, 15% to 35%, 15 to 28%, 20% to 30%, or 25% to 35%. In some embodiments, the arc-stabilizing agent is present at a concentration of 10%, 15%, 20%, 25%, 30%, 35%, or 40%, including any value and range therebetween.

In some embodiments, the term “rutile” refers to a crystalline TiO₂ mineral which is the most common natural form of TiO₂.

In some embodiments, the composition comprises a binder. In some embodiments, the binder comprises a silicate. In exemplary embodiments, a binder (e.g., silicate glass) may be present at a concentration of 20% to 70%, 20 to 30%, or 50% to 65%, by dry mix weight.

Non-limiting exemplary silicates (or liquid silicates) are sodium silicate, potassium silicate or a combination thereof. In some embodiments, the sodium silicate and the potassium silicate are present at a ratio of 2:1 to 1:2. In some embodiments, the sodium silicate and the potassium silicate are present at a ratio of about 3:2 to 1:2, respectively. In some embodiments the sodium silicate and the potassium silicate are present at a ratio of about 1:1.

In some embodiments, the composition comprises feldspar, e.g., potassium feldspar. In some embodiments, the potassium feldspar weight content is in the range of from 0.1% to 15%. In some embodiments, the potassium feldspar weight content is in the range of from 0.5% to 10%. In some embodiments, the potassium feldspar weight content is in the range of from 1.5% to 7%. In some embodiments, the potassium feldspar weight content is 1.5%, 1.8%, 2%, 2.4%, 2.8%, 3.2%, 3.6%, 4%, 4.4%, 4.8%, 5.2%, 5.6%, 6%, 6.4%, 6.8%, or 7%, including any value and range therebetween. In some embodiments, the potassium feldspar weight content is about 3.5%.

In some embodiments, the composition comprises sodium feldspar. In some embodiments, the sodium feldspar weight content is in the range of from 0.1% to 15%. In some embodiments, the sodium feldspar weight content is in the range of from 0.5% to 10%. In some embodiments, the sodium feldspar weight content is in the range of from 1.5% to 7%. In some embodiments, the sodium feldspar weight content is 1.5%, 1.8%, 2%, 2.4%, 2.8%, 3.2%, 3.6%, 4%, 4.4%, 4.8%, 5.2%, 5.6%, 6%, 6.4%, 6.8%, or 7%, including any value and range therebetween. In some embodiments, the sodium feldspar weight content is about 3%.

The phrases “potassium feldspar” and “sodium feldspar” refer herein to silicate minerals in which the silicate tetrahedral and aluminum tetrahedra are bound with potassium and sodium ions, correspondingly.

In some embodiments, the composition comprises sillitin. In some embodiments, the sillitin weight content is in the range of from 0.1% to 20%. In some embodiments, the sillitin weight content is in the range of from 0.5% to 10%. In some embodiments, the sillitin weight content is in the range of from 1.5% to 7%. In some embodiments, the sillitin weight content is 1.5%, 1.8%, 2%, 2.4%, 2.8%, 3.2%, 3.6%, 4%, 4.4%, 4.8%, 5.2%, 5.6%, 6%, 6.4%, 6.8%, or 7%, including any value and range therebetween. In some embodiments, the sillitin weight content is about 4%.

The term “sillitin” refers to a natural mixture of quartz and kaolinite.

In some embodiments, the composition comprises kaolin. In some embodiments, the kaolin weight content is in the range of from 0.1% to 10%. In some embodiments, the kaolin weight content is in the range of from 0.2% to 8%. In some embodiments, the kaolin weight content is in the range of from 0.5% to 4%. In some embodiments, the kaolin weight content is 0.5%, 0.8%, 1%, 1.4%, 1.8%, 2.2%, 2.6%, 3%, 3.4%, 3.8%, or 4%, including any value and range therebetween. In some embodiments, the kaolin weight content is about 2%.

The term “kaolin” refers to fine usually white clay which, without limitation, may be formed by the weathering of aluminous minerals.

In some embodiments, the composition comprises sodium bentonite. In some embodiments, the sodium bentonite weight content is in the range of from 0.1% to 15%. In some embodiments, the sodium bentonite weight content is in the range of from 0.5% to 10%. In some embodiments, the sodium bentonite weight content is in the range of from 1.5% to 7%. In some embodiments, the sodium bentonite weight content is 1.5%, 1.8%, 2%, 2.4%, 2.8%, 3.2%, 3.6%, 4%, 4.4%, 4.8%, 5.2%, 5.6%, 6%, 6.4%, 6.8%, or 7%, including any value and range therebetween. In some embodiments, the sodium bentonite weight content is about 3.5%.

The phrase “sodium bentonite” refers herein to absorbent aluminum phyllosilicate clay.

In some embodiments, the composition comprises rutile. In some embodiments, the rutile weight content is in the range of from 5% to 70%. In some embodiments, the rutile weight content is in the range of from 15% to 60%. In some embodiments, the rutile weight content is in the range of from 30% to 50%. In some embodiments, the rutile weight content is 30%, 31%, 32%, 33%, 34%, 35%, 36%, 37%, 38%, 39%, 40%, 41%, 42%, 43%, 44%, 45%, 46%, 47%, 48%, 49%, or 50%, including any value and range therebetween. In some embodiments, the rutile weight content is about 43.4%.

In some embodiments, the composition is in the form of a coating on a substrate. In some embodiments, the substrate comprises one or more metals. In some embodiments, the metal is an iron based alloy. In some embodiments, the iron based alloy is selected from, without being limited thereto, cast iron, and ductile iron, steel alloy comprising e.g., carbon steel, low and high alloy steel, stainless steel, cast iron, or ductile iron. In some embodiments, the metal is a nonferrous material. In some embodiments, the nonferrous material is selected from, without being limited thereto, nickel and copper, and their alloys, and aluminum.

In some embodiments, the composition comprises ferroalloy and boron, or an alloy thereof. The final boron content in may be in range of 0.004 to 0.008%, or 0.005 to 0.007, by weight. Upon coating, the content of boron in wire may be 0.002 to 0.004%, or 0.002 to 0.004%, by weight, in weld metal. In exemplary procedures, this composition comprising boron is devoid of borax, boric acid, and boric salts (e.g., as a component of a flux coating).

In some embodiments, the composition comprises zirconia.

In some embodiments, the zirconia is present at a concentration of 0.1% to 1.5%, e.g., 0.1%, 0.2%, 0.3%, 0.4%, 0.5%, 0.6%, 0.7%, 0.8%, 0.9%, 1%, or 1.5%, including any value and range therebetween.

In some embodiments, the zirconia is nanosized. In some embodiments, the zirconia is in the form of a powder.

Herein throughout, the terms “nanoparticle”, “nano”, or any grammatical derivative thereof, which are used herein interchangeably, describe a particle featuring a size of at least one dimension thereof (e.g., diameter, length) that ranges from about 1 nanometer to 1000 nanometers.

In some embodiments, the size of the particle described herein represents a median size of a plurality of nanoparticles.

In some embodiments, the median size (e.g., diameter, length) ranges from about 1 nanometer to 500 nanometers. In some embodiments, the average size ranges from about 1 nanometer to about 300 nanometers. In some embodiments, the average size ranges from about 1 nanometer to about 200 nanometers. In some embodiments, the average size ranges from about 1 nanometer to about 100 nanometers. In some embodiments, the average size ranges from about 1 nanometer to 50 nanometers, and in some embodiments, it is lower than 35 nm.

In some embodiments, the median size is about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 40 nm, about 42 nm, about 44 nm, about 46 nm, about 48 nm, or 50 nm, including any value therebetween.

The particle can be generally shaped as a sphere, a rod, a cylinder, a ribbon, a sponge, and any other shape, or can be in a form of a cluster of any of these shapes, or can comprises a mixture of one or more shapes.

In some embodiments, the composition comprises boron, titanium (e.g., ferrotitanium) and zircon. In some embodiments, the ferrotitanium to zircon weight ratio in the composition described herein is 50:1 to 1:50, or 10:1 to 1:10, e.g., 10:1, 9:1, 8:1, 7:1, 6:1, 5:1, 4:1, 3:1, 2:1, or 1:1, respectively, including any value and range therebetween. In some embodiments, the titanium (e.g., ferrotitanium) to boron weight ratio in the composition described herein is 50:1 to 1:50, or 10:1 to 1:10, e.g., 10:1, 9:1, 8:1, 7:1, 6:1, 5:1, 4:1, 3:1, 2:1, 1:1, respectively, including any value and range therebetween.

In some embodiments, the composition comprising zirconia, in an embodiment thereof, is characterized by V-charpy impact energy of 30 J to 80 J, e.g., 30 J, 35 J, 40 J, 45 J, 50 J, 55 J, 60 J, 65 J, 70 J, 75 J, 80 J, or 85 J, including any value and range therebetween, at −50 C°.

Exemplary Compositions

In exemplary embodiments, the composition comprises (percentages are by weight) 25-38% cellulose (e.g., 25%, 30%, 33%, or 38%, including any value and range therebetween) 4-7% (e.g., 4%, 5%, 6%, or 7%, including any value and range therebetween) deoxidizer, 25-35% (e.g., 25%, 30%, 33%, or 35%, including any value and range therebetween) arc stabilizer, 35-55% (e.g., 35%, 40%, 45%, or 55%, including any value and range therebetween) slag former, 5-7% (e.g., 5%, 6%, or 7%, including any value and range therebetween) alloying element, and 15-22% (e.g., 15%, 18%, or 22%, including any value and range therebetween) slag formers (e.g., carbonate). In exemplary embodiments, such composition is characterized by metal core diameter of 2 to 3.25 mm.

In additional exemplary embodiments, the composition comprises (percentages are by weight) 20-30% (e.g., 20%, 22%, 24%, 26%, 28%, or 30%, including any value and range therebetween) cellulose, 6-10% (e.g., 6%, 7%, 8%, 9%, or 10%, including any value and range therebetween) deoxidizer, 20-30% (e.g., 20%, 22%, 24%, 26%, 28% or 30%, including any value and range therebetween) arc stabilizer, 5-7% (e.g., 5%, 6%, or 7%, including any value and range therebetween) alloying element, and 20-40% (e.g., 20%, 25%, 30%, 35% or 40%, including any value and range therebetween) arc stabilizer (e.g., iron powder). In exemplary embodiments, such composition is characterized by metal core diameter of 4 mm or more.

In additional exemplary embodiments, the composition comprises (percentages are by weight) 25-60% (e.g., 25%, 30%, 35%, 40%, 45%, 50%, 55%, or 60%, including any value and range therebetween) calcium carbonate, 40-60% (e.g., 40%, 45%, 50%, 55% or 60%, including any value and range therebetween) flourspar, 10-18% (e.g., 10%, 12%, 14%, 16%, or 18%, including any value and range therebetween) deoxidizer, 15-28% arc stabilizer (e.g., iron powder) element (e.g., 15%, 20%, 22%, 24%, 26% or 28%, including any value and range therebetween), 6-10% (e.g., 6%, 7%, 8%, 9% or 10%, including any value and range therebetween) slag former, and 3-6% alloying element. In exemplary embodiments, such composition is characterized by metal core diameter of 4 mm or more.

In additional exemplary embodiments, the composition comprises (percentages are by weight) 1.5-4% (e.g., 1.5%, 2%, 2.5%, 3%, 3.5% or 4%, including any value and range therebetween) ferromanganese, 4-10% (e.g., 4%, 5%, 6%, 7%, 8%, 9% or 10%, including any value and range therebetween) ferro-alloys deoxidizer, 15-30% iron powder (e.g., 15%, 20%, 22%, 24%, 26%, 28% or 30%, including any value and range therebetween), 25-30% carbonate(s) (e.g., 25%, 26%, 27%, 28%, 29%, or 30%, including any value and range therebetween), 25-30% fluorspar (e.g., 25%, 26%, 27%, 28%, 29% or 30%, including any value and range therebetween), 8-18% slag formers (e.g., 8%, 9%, 10%, 11%, 12%, 13%, 14%, 15%, 16%, 17%, or 18%, including any value and range therebetween), 0.5-1.5% boric Acid (e.g., 0.5%, 1%, or 1.5%, including any value and range therebetween), 0.5-2% slipping agent (e.g., 0.5%, 1%, 1.5% or 2%, including any value and range therebetween), and 0.1-0.4% nickel powder (e.g., 0.1%, 0.2%, 0.3%, or 0.4%, including any value and range therebetween).

In additional exemplary embodiments, the composition comprises (percentages are by weight ±50%) about 2.7% ferromanganese, about 6.8% ferro-alloys deoxidizer, about 20.9% iron powder, 28.6% carbonate(s), about 25.1% fluorspar, about 12.4% slag formers, about 0.8-1% boric acid, about 1% slipping agent, and about 0.3% nickel powder.

In additional exemplary embodiments, the composition comprises (see e.g., Table 7 below, percentages are by weight): ferromanganese, ferro vanadium, durcal, ferro silicon, ferro titanium, hydroxyethyl cellulose, flourspar, iron powder, nickel powder, chromium oxide, quartz, rutile, tiofine, boric acid, and nanosized ZrO₂.

Further exemplary compositions are described herein below under the Examples Section.

In some embodiments, “ferromanganese” may be replaced with one or more from: ferromanganese low carbon, ferromanganese medium carbon, or pure metal manganese.

In some embodiments, “ferro-alloys deoxidizer” may be replaced with one or more from: ferrosilicon, ferrotitanium, ferroaluminum, chromium oxide, ferro-vanadium, or other possible deoxidizer powder for steel making.

In some embodiments, “carbonate” may be replaced with one or more from: calcium carbonate, and dolomite.

In some embodiments, “boric acid” may be replaced with one or more from: borax, or other different types of borates.

In some embodiments, “slipping agent” may be replaced with one or more from: sodium carboxyl methyl cellulose, or hydroxyl ethyl cellulose.

The Article

According to some embodiments of the present invention there is provided an article comprising the composition described herein in an embodiment thereof. In some embodiments, the article comprises a metal wire. In some embodiments, the composition described herein is in the form of a coating on the metal wire. In some embodiments, the article is a tubular welding wire. In some embodiments, the tubular welding wire is characterized by a diameter core metal wire in the range of from 1 mm to 10 mm. In some embodiments, the tubular welding wire is characterized by a diameter core metal wire in the range of from 1 to 6 mm. In some embodiments, the tubular welding wire is characterized by a diameter core metal wire in the range of from 4 to 6 mm. In some embodiments, the tubular welding wire is characterized by a diameter in the range of from 1.6 mm to 5 mm.

In some embodiments, the tubular welding wire is characterized by a diameter core metal wire in the range of from 1.5 mm to 65 mm, e.g., 1.5 mm, 5 mm, 10 mm, 15 mm, 20 mm, 25 mm, 30 mm, 35 mm, 40 mm, 45 mm, 50 mm, 55 mm, 60 mm, or 65 mm, including any value and range therebetween.

In some embodiments, the tubular welding wire is characterized by a diameter core metal wire of 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, or 10 mm, including any value and range therebetween.

In some embodiments, the tubular welding wire is characterized by a diameter core metal wire of less than 3.5, less than 3.4, less than 3.3, less than 3.2, less than 3.1, or less than 3 mm.

In some embodiments, the metal core diameter is about 1.8 to 3.5 mm and the cellulose to arc-stabilizer weight ratio in the composition described herein is 2:1, 1:1, or 1:2, including any value and range therebetween. In some embodiments, the cellulose to arc-stabilizer weight ratio is about 1:1.

In some embodiments, the metal core diameter is about 1.8 to 3.5 mm and the cellulose to slag former weight ratio in the composition described herein is 2:1, 1:1, or 1:2, including any value and range therebetween. In some embodiments, the cellulose to slag former weight ratio is about 1:1 to 1:1.5.

In some embodiments, the metal core diameter is about 1.8 to 3.5 mm and the deoxidizer to alloying element weight ratio in the composition described herein is 2:1, 1:1, or 1:2, including any value and range therebetween. In some embodiments, the deoxidizer to alloying element is about 1:1 to 1:1.2.

In some embodiments, the metal core diameter is 4 mm or more, and the cellulose to slag former weight ratio in the composition described herein is 10:1 to 2:1, including any value and range therebetween. In some embodiments, the cellulose to slag former weight ratio is about 8:1 to 5:1.

In some embodiments, the metal core diameter is 4 mm or more, and the deoxidizer to alloying element weight in the composition described herein is 1.5:1 to 1:1.5, including any value and range therebetween. In some embodiments, the cellulose to slag former weight ratio is about 1:1.

In some embodiments, the metal core diameter is 4 mm or more, and the cellulose to arc-stabilizer weight ratio in the composition described herein is 2:1, 1:1, or 1:2, including any value and range therebetween. In some embodiments, the cellulose to arc-stabilizer weight ratio is about 1:1.

In some embodiments, the metal core diameter is 4 mm or more, and the slag former to deoxidizer weight ratio in the composition disclosed herein is 3:1 to 1:3. In some embodiments, the metal core diameter is 4 mm or more and the deoxidizer to arc stabilizer weight ratio in the composition disclosed herein is 1:3 to 1.5:1. In some embodiments, the metal core diameter is 4 mm or more, and the slag former to alloying element weight ratio in the composition disclosed herein is 3:1 to 1:1. In some embodiments, the metal core diameter is 4 mm or more, and the arc stabilizer to slag former weight ratio in the composition disclosed herein is 1.5:1 to 5:1.

The phrase “welding wire” refers to a slim metallic rod that is ignited to generate a heated arc e.g., for the purpose of fusing metal pieces together (welding) by rendering the wire soft via hammering or compressing under an applied heat source. In arc welding, an electrode may be used to conduct current through a workpiece to fuse two pieces together. Depending upon the process, the electrode may be either consumable, e.g., in the case of gas metal arc welding or shielded metal arc welding, or non-consumable, such as in gas tungsten arc welding.

In some embodiments, the article comprises the coating described herein, is in the form of a welding flux.

The phrase “welding flux” refers to the insulating covering of the metal core welding wire. The flux may give off gases as it decomposes to prevent weld contamination, introduce deoxidizers to purify the weld, cause weld-protecting slag to form, improve the arc stability, or may provide alloying elements to improve the weld quality.

In some embodiments, the article is a shielded arc electrode.

The phrase “shielded arc electrode” refers to a welding wire coated with welding flux that driven the shielded metal arc welding process, in which an electrical circuit may be established to strike an arc between the electrode and the metal substrates, providing heat source, whereas further the coated wire may be melted to fill spaces between parts.

In some embodiments, the shielded arc electrode is a welding consumable.

The phrase “welding consumable” may refer to a welding wire, or a flux coated wire, that consume during the arc welding process, providing the materials and atmospheric protection to the weld zone.

In some embodiments, the welding consumable comprises manganese. In some embodiments, manganese weight content is in the range of from 1% to 2%. In some embodiments, manganese weight content is in the range of from 1.2% to 1.8%. In some embodiments, manganese weight content is in the range of from 1.5% to 1.7%. In some embodiments, the manganese weight content is 1.5%, 1.51%, 1.52%, 1.53%, 1.54%, 1.55%, 1.56%, 1.57%, 1.58%, 1.59%, 1.6%, 1.61%, 1.62%, 1.63%, 1.64%, 1.65%, 1.66%, 1.67%, 1.68%, 1.69%, or 1.7%, including any value and range therebetween. In some embodiments, the manganese weight content is about 1.66%.

In some embodiments, the welding consumable comprises boron. In some embodiments, boron weight content is in the range of from 0.02% to 0.08%. In some embodiments, boron weight content is in the range of from 0.03% to 0.07%. In some embodiments, boron weight content is in the range of from 0.04% to 0.06%. In some embodiments, the boron weight content is 0.04%, 0.041%, 0.042%, 0.043%, 0.044%, 0.045%, 0.046%, 0.047%, 0.048%, 0.049%, 0.05%, 0.051%, 0.052%, 0.053%, 0.054%, 0.055%, 0.056%, 0.057%, 0.058%, 0.059%, or 0.06%, including any value and range therebetween. In some embodiments, the boron weight content is about 0.05%.

In some embodiments, the welding consumable comprises nickel. In some embodiments, the welding consumable is substantially devoid of nickel. In some embodiments, by “substantially devoid of nickel” it is meant to refer to less than 0.2%, less than 1%, less than 0.05%, by weight, or even completely devoid of nickel.

In some embodiments, nickel weight content is up to 0.3%, by weight. In some embodiments, nickel weight content is in the range of from 0.1% to 0.3%. In some embodiments, nickel weight content is in the range of from 0.15% to 0.3%. In some embodiments, the nickel weight content is 0.15%, 0.16%, 0.17%, 0.18%, 0.19%, 0.2%, 0.21%, 0.22%, 0.23%, 0.24%, 0.25%, 0.26%, 0.27%, 0.28%, 0.29%, or 0.3%, including any value and range therebetween. In some embodiments, the nickel weight content is about 0.21%.

In some embodiments, the welding consumable comprises chromium. In some embodiments, the welding consumable is devoid of chromium. In some embodiments, chromium weight content is up to 0.2%, by weight. In some embodiments, chromium weight content is in the range of from 0.01% to 0.2%. In some embodiments, chromium weight content is in the range of from 0.05% to 0.2%. In some embodiments, the nickel weight content is 0.01%, 0.02%, 0.03%, 0.04%, 0.05%, 0.1%, 0.15%, or 0.2%, including any value and range therebetween.

In some embodiments, the welding consumable comprises vanadium (e.g., in the form of ferrovanadium). In some embodiments, the welding consumable is devoid of vanadium. In some embodiments, vanadium weight content is up to 0.1%, by weight. In some embodiments, vanadium weight content is up to 0.08%, by weight. In some embodiments, the vanadium weight content is in the range of from 0.01% to 0.08%. In some embodiments, the vanadium weight content is in the range of from 0.02% to 0.8%. In some embodiments, the vanadium content is 0.01%, 0.02%, 0.03%, 0.04%, 0.05%, 0.06%, 0.07%, or 0.08%, including any value and range therebetween.

In some embodiments, the welding consumable comprises dolomite. In some embodiments, the dolomite weight content is at least 2%. In some embodiments, the dolomite weight content is in the range of from 2% to 8%. In some embodiments, the dolomite weight content is in the range of from 3% to 6%. In some embodiments, the dolomite weight content is in the range of from 3.5% to 4.5%. In some embodiments, the dolomite weight content is 3.5%, 3.6%, 3.7%, 3.8%, 3.9%, 4%, 4.1%, 4.2%, 4.3%, 4.4%, or 4.5%, including any value and range therebetween. In some embodiments, the dolomite weight content is about 3.9%.

In some embodiments, the welding consumable is configured to form a weld metal on a metal-alloy workpiece. In some embodiments, the weld metal comprises less than 0.3 wt % nickel. In some embodiments, the weld metal comprises less than 0.29 wt % nickel. In some embodiments, the weld metal comprises less than 0.25 wt % nickel. In some embodiments, the weld metal comprises less than 0.2 wt % nickel. In some embodiments, the weld metal comprises less than 0.15 wt % nickel. In some embodiments, the nickel weight content is in the range of from 0.001% to 0.3%. In some embodiments, the nickel weight content is in the range of from 0.01% to 0.3%. In some embodiments, the nickel weight content is in the range of from 0.1% to 0.3%.

The term “weld” refers to a localized fusion of metals produced by heating.

The phrase “weld metal” refers to the material that has melted and re-solidified, as a result of the welding operation. The material may contain elements sourced from the metallic substrates, the consumable core metallic wire and the consumable flux (electrode coating).

In some embodiments, the metal-alloy workpiece is an iron based alloy. In some embodiments, the iron based alloy is selected from, without being limited thereto, carbon steel, low and high alloy steel, stainless steel, cast iron, ductile iron, or any combination thereof. In some embodiments, the metal-alloy workpiece is a nonferrous material. In some embodiments, the nonferrous material is selected from, without being limited thereto, nickel and copper, and their alloys, aluminum, or any combination thereof.

In some embodiments, the welding consumable is configured to reduce manganese emission during welding operation as compared to a standard manganese containing electrode known to one skilled in the art, in a value of 10%, 20%, 30%, 40%, or 50%, including any value and range therebetween. In some embodiments, the welding consumable is configured to reduce manganese emission in a value of at least 30%.

The Process

According to an aspect of some embodiments of the present invention there is provided a method of depositing a weld metal on a surface, comprising the steps of: (a) advancing a welding consumable toward a metal-alloy workpiece, (b) establishing an arc between a welding electrode and the metal-alloy workpiece, so as to melt a portion of the welding consumable and a portion of the metal-alloy workpiece, thereby depositing the weld metal on the surface.

In some embodiments, the welding consumable comprises a composition disclosed hereinabove in an embodiment thereof.

In some embodiments, the welding consumable comprises (by weight) 1-4% ferromanganese, 2-4% ferromanganese, or 2-3% ferromanganese. In some embodiments, the welding consumable comprises (by weight) 0.3-2% boron, 0.5-2% boron, or 0.5-1.5% boron.

In some embodiments, the welding consumable comprises (by weight) at least 0.5% carbonate, at least 1% carbonate, at least 1.5% carbonate, at least 2% carbonate, at least 2.5% carbonate, at least 3% carbonate, or 3.5% carbonate.

Properties

In some embodiments, the weld metal described herein is characterized by ductility of from 20% to 35% elongation as compared to the original material length. In some embodiments, the weld metal described herein is characterized by ductility of from 25% to 30% elongation as compared to the original material length. In some embodiments, the weld metal described herein is characterized by ductility of 25%, 25.5%, 26%, 26.5%, 27%, 27.5%, 28%, 28.5%, 29%, 29.5%, or 30% elongation, including any value and range therebetween, as compared to the original material length.

In some embodiments, the weld metal described herein is characterized by yield point of from 400 to 600 MPa. In some embodiments, the weld metal described herein is characterized by yield point of 400 MPa, 450 MPa, 500 MPa, or 550 MPa, including any value and range therebetween. In exemplary embodiments, the weld metal described herein is characterized by yield point of about 520 MPa.

In some embodiments, the weld metal described herein is characterized by ultimate tensile strength (UTS) of from 500 to 700 MPa. In some embodiments, the weld metal described herein is characterized by yield point of 500 MPa, 550 MPa, 600 MPa, 650 MPa, or 700 MPa, including any value and range therebetween. In exemplary embodiments, the weld metal described herein is characterized by yield point of about 580 MPa.

The term “ductility” refers to a solid material's ability to deform under tensile stress, which may be characterized by the material's ability to be stretched into a wire.

In some embodiments, the weld metal described herein in an embodiment thereof is characterized by an averaged V-Charpy impact energy of from 40 J to 100 J at 0° C. In some embodiments, the weld metal described herein is characterized by an averaged V-Charpy impact energy of from 100 J to 150 J at −30° C. In some embodiments, the weld metal is characterized by an averaged V-Charpy impact energy of from 50 J to 80 J at 0° C. In some embodiments, the weld metal is characterized by an averaged V-Charpy impact energy of from 55 J to 70 J at 0° C. In some embodiments, the weld metal, is characterized by an averaged V-Charpy impact energy of 55 J, 56 J, 57 J, 58 J, 59 J, 60 J, 61 J, 62 J, 63 J, 64 J, 65 J, 66 J, 67 J, 68 J, 69 J, or 70 J, including any value and range therebetween, at 0° C. In some embodiments, the weld metal is characterized by an averaged V-Charpy impact energy of from 60 J to 64 J at 0° C.

In some embodiments, the weld metal described herein is characterized by an averaged V-Charpy impact energy of from 100 J to 150 J at −30° C.

In some embodiments, the weld metal described herein is characterized by an averaged V-Charpy impact energy of from 50 J to 150 J at −50° C.

The phrase “V-Charpy impact energy” refers to a toughness characteristic measure unit of the Charpy impact test, which is a standardized high strain-rate test that determines the amount of energy absorbed by a material during fracture.

In some embodiments, the weld metal described herein further comprises silicon (e.g., silicate). In some embodiments, the silicon weight content is in the range of from 0.1% to 0.4%. In some embodiments, the silicon weight content is in the range of from 0.2% to 0.3%. In some embodiments, the silicon weight content is 0.2%, 0.21, 0.22%, 0.23, 0.24%, 0.25%, 0.26, 0.27%, 0.28, 0.29%, or 0.3%, including any value and range therebetween. In some embodiments, the silicon weight content is in the range of from 0.2% to 0.22%.

General

As used herein the term “about” refers to ±20%.

The terms “comprises”, “comprising”, “includes”, “including”, “having”, and their conjugates, mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, electrochemical and physical arts.

As used herein, the term “treating” includes abrogating, substantially inhibiting, slowing or reversing the progression of a condition, substantially ameliorating symptoms of a condition or substantially preventing the appearance symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

The hereinbelow experiments provide a new approach for achieving low manganese emission welding consumable.

### Example 1

### Low Manganese Flux Composition

In exemplary procedures, the reference for development was chosen to be the standard E6013 electrode (Z-11). Manganese emission was further measured in comparison to Z-11 electrode.

In exemplary procedures, 25-26% wt of potassium silicate was added to get a wet mix. The ratio of flux coating diameter to core wire diameter in wet condition for 3.25 mm welding electrode immediate after extrusion was approximately 1.67.

The Baking condition was 100° C. for 2 hours. After baking the metal core was around 66 weight-percent of whole electrode end rest is flux coating.

The manganese content in the metal core was 0.4 wt %. Thus, the total manganese content in welding consumable was calculated as follows: 0.4×0.66+10×0.34=3.6%. There was some dry remainder from liquid silicate but it could be neglected for rough evaluation. The flux composition of Z-11 is presented in Table 1.

TABLE 1
Flux coating composition of Z-11 welding electrode

| Content in dry mix | |
|---|---|
| (wt-%) | Material Name |
| 10 | Fe—Mn affine LC |
| 2-14 | Dolomite |
| 2-8 | Cellulose |
| 2-16 | Iron powder |
| 2-10 | Feldspars |
| 4-15 | Slag Formers |
| 45-55 | Rutile |

Low Manganese Formulations:

In order to reduce manganese, a partial substitution with nitrogen was examined. Nitrogen substitution was attained by partially and gradually substitution of ferromanganese powder in flux coating by nitronized ferromanganese or nitronized manganese powders. Experiments of manganese measurements in fume showed that the manganese quantity in the fume was reduced but also that manganese content in weld metal was decreased respectively, which brought to severe dropping in mechanical properties of weld metal. The addition of nitrogen further caused ricing of yield point and UTS values and some tendency to a formation of porosity in weld metal.

Based on the findings above, the main challenge of the research was to obtain high enough elongation of weld metal and high enough values of impact energy which were conditioned by reduced manganese content in weld metal.

Further, alloying systems of Ti—B—N(titanium, boron and nitrogen) and V—N(vanadium and nitrogen) were examined as the substituents of manganese. These substituents yielded an impact energy and an elongation values lower than the known standards.

During the research boron element was observed as an element which improves toughness of weld metal.

Next, nickel was further chosen as a candidate for partial substitution of manganese. American AWS A.5 and European EN ISO 2560 standards allow maximum nickel content to be 0.3 wt % in weld metal. It was observed that addition of nickel in this range improved elongation of weld metal, however, low impact values were further observed. Therefore, it was decided to reduce silicon content in weld metal to get improvement of toughness. This effect can be reached by oppression of silicon redox reaction. Flux coating basic index raising can be a suitable and relatively simple way. Thus, dolomite content was gradually increase from 8% up to 14%. Indeed, this formulation allowed decreasing of silicon content in weld metal approximately from 0.27-0.29 wt. % to 0.20-0.22 wt. %. Table 2 presents flux coating composition for the low-manganese electrode.

TABLE 2

| Content in dry mix (wt-%) | Material Name |
|---|---|
| 6.0/4.8 | Fe—Mn affine LC/Mn |
| 2-14 | Dolomite |
| 4-10 | Cellulose |
| 2-16 | Iron powder |
| 4-12 | Feldspars |
| 4-16 | Slag Formers |
| 45-50 | Rutile |
| 1.5> | Boric Acid/Borax |
| 1.0> | Nickel powder |

In additional exemplary procedures, the following steps were applied: increasing the nickel content up to 0.3 wt % in weld metal by addition of nickel powder to flux coating; boron micro alloying (performed by addition of 1 wt-% of boric acid to flux coating); and increasing the dolomite content up to 14 wt-%.

Application of the above mechanisms provided weld metal elongation of 27% and approximately average of 60-64 J for V-charpy impact energy at 0° C. These results fulfil the requirements of international standards (Table 3).

TABLE 3
Requirements for mechanical properties of weld metal

| | Yield | | | V-charpy |
|---|---|---|---|---|
| | point | UTS | Elongation | Impact energy |
| Type of standard | (MPa) | (MPa) | (%) | at 0° C. (J) |
| AWS A5.1 E6013 | 330 | 430 | 17 | — |
| EN ISO 2560-A | 380/420 | 470-600/ | 20 | 47 |
| E 38/42 0 RR 12 | | 500-640 | | |
| AWS A5.1 E7018 | 400 | 490 | 22 | 27 at −30° C. |
| EN ISO 2560-A E | 460 | 530-680 | 20 | 47 at −30° C. |
| 46 3 B | | | | |

Preliminary manganese emission measurements showed that the quantity of manganese compounds in the fume were decreased significantly, at least in 2 to 2.5 times compared to Z-11 electrode.

Substitution of boric acid by borax also allowed to receive suitable mechanical properties of all weld metal.

The developed low-manganese welding consumable (coated electrode) comprised manganese, boron, dolomite and nickel weight content is 1.66% Mn, 0.05% boron, 3.94% dolomite and 0.21% nickel.

### Example 2

### Further Low Manganese Flux Composition

The hereinbelow experiments provide another new approach for achieving low manganese emission welding consumable.

In exemplary embodiments, green coloring of flux coating was provided for all types of low manganese emission electrodes. The solution has been implemented by addition of 0.5% of green pigment, which is based on chromium oxide (Cr₂O₃; minimal purity of 99.1%). Chromium oxide also functions as a deoxidizer, and it improved the purity of the weld metal.

Technical Solution

The starting material was based on a coating of basic electrodes which comprises a large amount of alkaline-earth metals carbonates, main of them are marble (CaCO₃) and fluorspar (CaF₂). In addition, there were small amounts of quartz sand and rutile. Ferrotitanium, ferrosilicon, and ferromanganese and sometimes ferroaluminum were used as deoxidizers. The binders were liquid sodium silicate or mixed sodium-potassium silicates. Shielding gases were provided by thermal decomposition of CaCO₃.

Table 4 below presents an exemplary low manganese formula (“E7018”).

TABLE 4

| | Concentration Range for |
|---|---|
| Material | Presentation (wt. %) |
| Ferromanganese* | 1.5-4 |
| Ferro-alloys deoxidizers | 4-10 |
| Iron powder* | 15-30 |
| Carbonates | 25-30 |
| Fluorspar | 25-30 |
| Slag formers | 8-18 |
| Boric Acid | 0.5-1.5 |
| Slipping agent | 0.5-2 |
| Nickel Powder* | 0.1-0.4 |

*For example, Ferromanganese 2.7%, Iron powder 20.9%, Nickel 0.3%

It is to note that regular E7018 flux coating absorbs moisture during storing, thus re-drying of electrodes was performed before welding. Without being bound by any particular mechanism, the main reason for drying is unwanted diffusible hydrogen content in weld metal, which may cause hydrogen brittleness. The main hydrogen source is derived from excessive moisture in coating.

In exemplary procedures, the wet mix was obtained by addition of liquid silicates. The approximate liquid silicate quantity was 25 wt. % of dry mix. The ratio between sodium silicate and potassium silicate was 1:1. The coating ratio was 1.8. This coating material system allowed the ability to avoid moisture absorbance. The formula allowed to receive moisture content below 0.4 wt. % after prolonged storage (at least 9 hours) at 27° C. and 80% of relative humidity. Thus, electrode can be designated with symbol “R” acc. to AWS A5.1. This particular property was achieved due to the presence of ˜1% of Boric acid and ˜1% of hydroxyl ethyl cellulose (HEC). Apparently, the reaction between these materials caused formation of thin hydrophobic layer which repelled water and avoided moisture absorption.

In exemplary procedures, manganese content was reduced twice in comparison with regular E7018 electrodes. An exemplary source of manganese was ferromanganese powder and its content was reduced compared to regular ˜6% in flux coating to ˜3%.

The deficiency of manganese was compensated in order to receive proper elongation and V-charpy impact energy at −30 C°. In exemplary procedures, ˜0.3% nickel, ˜1% boric acid, micro alloying with vanadium, and 0.2% ferrovanadium powder were added to the flux.

A typical chemical composition of weld metal is provided in Table 5 below:

TABLE 5

| C | Mn | Si | Ni | Cr | V | B | P | S | Fe |
|---|---|---|---|---|---|---|---|---|---|
| 0.06 | 0.7 | 0.4 | 0.25 | 0.15 | 0.01 | <0.005 | <0.025 | <0.02 | bal. |

Typical mechanical properties are provided in Table 6.

TABLE 6

| | | | Impact Energy |
|---|---|---|---|
| Yield Point (MPa) | UTS (MPa) | Elongation (%) | (J) @−30 C.° |
| 520 | 580 | 27 | ~130 |

E7018-1 LMn Electrode

Following the two ways to receive E7018-1 coated welding electrode for lowered content of manganese, instead of regular 1.1-1.4 wt-% manganese content, this electrode provides weld metal with 0.6-0.7 wt-% manganese content.

E7018-1 designation according to AWS A5.1 standard means that weld metal will pass impact test at −45 C.° with minimum average of 27 Joules, Equivalent European designation according to EN ISO 2560-A standards is E 46 5 B X X defining that weld metal must pass impact test at −50 C.° with minimum average of 47 Joules.

The first way and relatively expensive one is based on usage of zirconium oxide nano powder. As a basis, existing E7018-LMn (low manganese) formula was taken (was described before). The idea behind usage of is that these fine particles can be nucleation sites during solidification of weld metal and subsequent phase transformation. Existence of such nucleation sites causes formation of denser acicular perlite phase, which should improve impact resistance of weld metal.

In order to examine this effect ZrO₂ nanoparticles were added with different weight percent of 0%, 0.25%, 0.5% and 0.75% to the dry powder composition as shown in Table 7, presenting Dry Mix Composition for E7018-1 LMn electrodes coating with different ZrO₂ nanoparticles content.

TABLE 7
Powder Composition (wt %)

| | K364-0% | K365-0.25% | K366-0.5% | K367-0.75% |
|---|---|---|---|---|
| Material | Nano ZrO₂ | Nano ZrO₂ | Nano ZrO₂ | Nano ZrO₂ |
| Ferromanganese | 2.7 | 2.7 | 2.7 | 2.7 |
| Ferro Vanadium | 0.2 | 0.2 | 0.2 | 0.2 |
| Durcal | 28.5 | 28.5 | 28.5 | 28.5 |
| Ferro Silicon | 2.3 | 2.3 | 2.3 | 2.3 |
| Ferro Titanium | 4.5 | 4.5 | 4.5 | 4.5 |
| Hydroxyethyl | 1.0 | 1.0 | 1.0 | 1.0 |
| Cellulose | | | | |
| Flourspar | 25.0 | 25.0 | 25.0 | 25.0 |
| Iron Powder | 20.8 | 20.8 | 20.8 | 20.8 |
| Nickel Powder | 0.6 | 0.6 | 0.6 | 0.6 |
| Chromium Oxide | 0.5 | 0.5 | 0.5 | 0.5 |
| Quartz | 5.0 | 5.0 | 5.0 | 5.0 |
| Rutile | 7.4 | 7.4 | 7.4 | 7.4 |
| Tiofine | 0.6 | 0.6 | 0.6 | 0.6 |
| Boric Acid | 1.0 | 1.0 | 1.0 | 1.0 |
| ZrO₂_{^{−}} 20 [nm] | 0 | 0.25 | 0.50 | 0.75 |

The chemical composition of weld metal are shown in Table 8, presenting the actual chemical Composition of weld metal for E7018-1 LMn electrodes with different ZrO₂ nanopowder content.

TABLE 8
Actual Chemical Composition (wt %)

| | C | Mn | Si | P | S | Cr | Ni | Mo | V | Ti | B | Zr |
|---|---|---|---|---|---|---|---|---|---|---|---|---|
| K364 - 0% | 0.066 | 0.68 | 0.432 | 0.017 | 0.0061 | 0.156 | 0.295 | 0.0088 | 0.052 | 0.024 | 0.004 | 0.0023 |
| Nano ZrO₂ | | | | | | | | | | | | |
| K365- 0.25% | 0.065 | 0.59 | 0.342 | 0.019 | 0.0067 | 0.15 | 0.312 | 0.0063 | 0.047 | 0.015 | 0.0029 | 0.0023 |
| Nano ZrO₂ | | | | | | | | | | | | |
| K366 - 0.5% | 0.057 | 0.64 | 0.323 | 0.014 | 0.0069 | 0.171 | 0.302 | 0.0068 | 0.058 | 0.014 | 0.0029 | 0.0023 |
| Nano ZrO₂ | | | | | | | | | | | | |
| K367- 0.75% | 0.057 | 0.62 | 0.344 | 0.017 | 0.0069 | 0.146 | 0.276 | 0.0094 | 0.05 | 0.013 | 0.0043 | 0.0017 |
| Nano ZrO₂ | | | | | | | | | | | | |

Table 9 below presents the impact test results, showing the V-charpy impact energy for E7018-1 LMn electrodes with different ZrO₂ nanoparticles content.

TABLE 9
V- charpy impact energy (J) @−50 C. °

| | 1 | 2 | 3 | 4 | 5 | Average |
|---|---|---|---|---|---|---|
| K364 - 0% | *117 | 30 | 26 | 70 | 15 | 35 |
| Nano ZrO₂ | | | | | | |
| K365 - 0.25% | 46 | 25 | 48 | 22 | 22 | 33 |
| Nano ZrO₂ | | | | | | |
| K366 - 0.5% | 67 | 8 | 37 | 28 | 28 | 48 |
| Nano ZrO₂ | | | | | | |
| K367 - 0.75% | 58 | 92 | 61 | 92 | 92 | 79 |
| Nano ZrO₂ | | | | | | |

*result was not included in the average calculation

To Summarize, the addition of 0.75 weight-percent of 20 nm zirconia nanopowder allows to pass v-charpy impact test according to the American and European standards.

The second way was based on usage of higher content of ferrotitanium coupled with the presence of boron, as shown in Table 10 below showing the dry mix composition for E7018-1 LMn electrodes (without usage of Nickel).

This formulation allows to avoid use of expensive nickel element for achievement of desirable impact resistance.

Without being bound by any particular theory, it is likely that boron reacts with titanium and produce stable borides compound which can be sites for nucleation during phase transformation. This process causes the formation of dense acicular ferrite phase which has good toughness.

TABLE 10
Powder Composition (wt %)

| Material | K440 |
|---|---|
| Ferromanganese | 3.0 |
| Girolit | 29.0 |
| Ferro Silicon | 4.0 |
| Ferro Titanium | 3.8 |
| Zircon | 4.0 |
| Flourspar | 23.0 |
| Iron Powder | 23.8 |
| Rutile | 6.0 |
| Tiofine | 1.5 |
| Carboxy Methyl Cellulose | 1.0 |
| Boric Acid (Source For Boron) | 0.6 |
| Chromium Oxide Green | 0.5 |

The Results of chemical composition of weld metal are shown in Table 11, presenting the Actual Chemical Composition of weld metal for E7018-1 LMn electrodes.

TABLE 11
Actual Chemical Composition (wt %)

| | C | Mn | Si | P | S | Cr | Ni | Mo | V | Ti | B | Zr |
|---|---|---|---|---|---|---|---|---|---|---|---|---|
| K440 | 0.062 | 0.91 | 0.51 | 0.015 | 0.0087 | 0.176 | 0.05 | 0.015 | 0.0052 | 0.043 | 0.004 | 0.0024 |

In Table 12, the impact test results are shown, presenting the V-charpy impact energy for E7018-1 LMn electrodes with higher ferro silicon and ferro titanium content.

TABLE 12
V- charpy impact energy (J) @−50 C. °

| | 1 | 2 | 3 | 4 | 5 | Average |
|---|---|---|---|---|---|---|
| K440 | 81 | 93 | 79 | 62 | *33 | 79 |

*This result was not included in the average calculation.

To Summarize, sufficient mechanical properties of weld metal for E7018-1 with significantly lowered manganese can be achieve without nickel usage by combined effect of titanium and boron.

### Example 3

### Cellulose Compositions

Technical Solution

As described above, the starting material was based on a coating of basic electrodes which comprised alkaline-earth metals carbonates. In addition, there were small amounts of quartz sand and rutile. Ferromanganese, chromium oxide, or their combination were used as deoxidizers.

Again, the aim was decreasing of manganese source content at least by 40-50% in comparison with regular flux compositions. As described herein, most common source for manganese is ferromanganese (80% Fe) powder, and in rare cases it may be electrolytic pure manganese powder.

In exemplary procedures, boron was introduced by the addition of boric acid, borax, and/or lithium tetraborate as exemplified in Table 13 below. In exemplary procedures, boric acid was added.

TABLE 13

| Source of boron | Content range in dry mix (wt. %) |
|---|---|
| Borax | 0.8-1.2 |
| Boric acid | 0.5-1.2 |
| Lithium tetraborat | 0.3-0.9 |

Table 14 below presents an exemplary low manganese formula comprising cellulose, having metal core diameters of 2.0-3.25 mm. The dry mix is shown below in Table 14:

TABLE 14

| weight-% | Material/component |
|---|---|
| 5 | Ferromanganese 1.5% |
| 8 | Magnesite (magnesium carbonate) |
| 5 | Calcium carbonate |
| 6 | Sodium carbonate anhydrous |
| 33 | Cellulose |
| 6 | Talkum-talc |
| 5 | China clay-102 kauline-10 |
| 5 | Quartz (ground silica) |
| 20.45 | Rutile |
| 2 | Titanium dioxide |
| 3 | Potassium titanate anatase |
| 0.75 | Nickel powder |
| 0.6 | Boric acid |
| 0.25 | Chromium oxide green hc-257 |
| 0.25 | Green pigment |

The Cellulosic electrode was characterized by a thin coating and low mass coefficient (15-25%). The coating of the cellulosic electrodes contained 20-45 wt. % of cellulose powder. While burning in welding arc this powder produced shielding gases, which protected melted metal from reaction with air.

The binders were liquid glass which is mix of potassium silicate and sodium silicate in a ratio of 2:3, with a total weight of liquid glass being 65% of dry mix weight. The range may be presented as 55-70% weight of dry mix, with the ratio between the potassium silicate to sodium silicate being 30:70 to 45:55.

The shielding gases were provided by thermal decomposition of CaCO₃.

In additional exemplary procedures, a core diameter of 4 mm or bigger was prepared with the following flux coating formula (Table 15):

TABLE 15

| Weight (%) | Material/component |
|---|---|
| 3.7 | Ferromanganese 1.5% |
| 2.5 | Magnesite (magnesium carbonate) |
| 1.8 | Calcium carbonate |
| 24.5 | Cellulose |
| 38.5 | Iron powder |
| 1.8 | Talc |
| 3.8 | Micaceous iron oxide |
| 18.55 | Rutile |
| 3 | Titanium dioxide |
| 0.75 | Nickel powder |
| 0.6 | Boric acid |
| 0.25 | Chromium oxide green |
| 0.25 | Green pigment |

In additional exemplary procedures, the wet mix was obtained by addition of liquid glass to the dry mix. The mix of potassium silicate and sodium silicate was present in a ratio of about 1:1 (45:55 to 55:45), with the total weight of liquid glass being 25% of the dry mix weight. Taken together, 25-30% weight of the dry mix was used. This coating material system allows the ability to avoid moisture absorbance.

### Example 4

### Boron Compositions

In exemplary procedures, alloying of weld metal with boron element was obtained through alloying of core wire. Molten steel was alloyed with Ferro-Boron prior to casting. The final boron content in drawn wire was in range 0.005-0.007 wt %. This content of boron in wire is estimated to supply content of 0.003-0.004 wt % in weld metal. In exemplary procedures, this process does not require the use of borax, boric acid, or boric salts as a component of flux coating.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A composition comprising manganese or a compound thereof, a cellulosic material, a carbonate, titanium, and at least one member selected from the group consisting of an alloying agent, a slag-forming agent, an arc-stabilizing agent, and any combination thereof, wherein the cellulosic material is present at a concentration of 1% to 40%, by weight, and wherein the manganese or a compound thereof is present at a concentration of 0.5 to 5%, by weight.

2. The composition of claim 1, wherein the carbonate comprises calcium carbonate.

3. (canceled)

4. The composition of claim 1, further comprising a compound comprising boron selected from; boric acid and borax, or any combination thereof, optionally wherein the weight content of the boron is in the range of 0.004 to 0.2%.

5. The composition of claim 4, comprising nickel at a concentration of less than 1%, by weight, optionally wherein the weight content of the nickel is in the range of 0.1 to 0.2%.

6. (canceled)

7. (canceled)

8. (canceled)

9. (canceled)

10. The composition of claim 1, wherein the cellulosic material is present at a concentration of 20 to 40%, by weight, optionally wherein said cellulosic material is selected front the group consisting of: sodium carboxyl methyl cellulose, hydroxyl ethyl cellulose, and a combination thereof.

11. (canceled)

12. The composition of claim 1, comprising any one of: (i) fluorite, (ii) a deoxidizer selected from the group consisting of chromium oxide, ferroalloy material, zircon and a combination thereof; and (iii) any combination of (i)-(ii).

13. The composition of claim 12, wherein said ferroalloy material comprises a material selected from the group consisting of ferromanganese, ferrosilicon, ferrotitanium, and a combination thereof.

14. The composition of claim 1, wherein any one of: (i) said slag-forming agent is selected from the group consisting of: quartz, titania optionally in the form of rutile, alumosilicate, and any combination thereof; (ii) said alloying agent comprises a material selected from the group consisting of: ferromanganese, boric acid, nickel, and any combination thereof.

15. (canceled)

16. (canceled)

17. The composition of claim 1, wherein said arc-stabilizing agent comprises any one of: (i) a material selected from the group consisting of: titania, metal carbonate, potassium titanate, and any combination thereof; and (ii) iron.

18. (canceled)

19. The composition of claim 17, wherein said metal carbonate comprises one or more materials selected from: sodium carbonate, magnesium carbonate, calcium carbonate, or any combination thereof.

20. The composition of claim 17, wherein said metal carbonate is in the form of dolomite.

21. The composition of claim 20, wherein said dolomite is present at a concentration in the range of from 8% to 16%.

22. The composition of claim 1, wherein anyone of: (i) said manganese comprises ferromanganese, (ii) said deoxidizer is present at a concentration selected from 4 to 10% or 10 to 18%, by total weight; (iii) said carbonate is present at a concentration of 15 to 40%, by total weight, (iv) said arc stabilizer is present at a concentration of 15 to 35%, by total weight; (v) said alloying element is present at a concentration of 2 to 7%, by total weight.

23. (canceled)

24. (canceled)

25. (canceled)

26. (canceled)

27. (canceled)

28. (canceled)

29. (canceled)

30. The composition of claim 1, wherein said slag-forming agent is present at a concentration selected from 35 to 55%, or 4% to 8%, by total weight.

31. (canceled)

32. The composition of claim 1, further comprising nanosized zirconia.

33. The composition of claim 1, being in the form of a coating on a substrate, optionally wherein anyone of (i) said substrate comprises one or more metals and (ii) said coating is in the form of a welding flux.

34. (canceled)

35. An article comprising the composition of claim 1, said article comprising a metal wire, and said composition being in the form of a coating on said metal wire, optionally wherein said electrode is configured to form a weld metal on a steel workpiece, wherein said weld metal comprises less than 0.3 wt % nickel.

36. The article of claim 35, wherein said article is selected from (i) a tubular welding wire, optionally wherein said tubular welding wire is characterized by a diameter of a core metal wire in the range of 1.5 to 6 mm; a shielded arc electrode.

37. (canceled)

38. (canceled)

39. (canceled)

40. (canceled)

41. (canceled)

42. (canceled)

43. (canceled)

44. A method of depositing a weld metal on a surface, comprising the steps of:
(a) advancing a welding consumable toward a metal-alloy workpiece, optionally wherein the metal-alloy is a steel alloy, wherein the welding consumable comprises the composition of claim 1; and
(b) establishing an arc between a welding electrode and the metal-alloy workpiece so as to melt a portion of said welding consumable and a portion of the metal-alloy workpiece;
thereby depositing said weld metal on said surface.

45. (canceled)

46. The method of claim 44, wherein anyone of: (i) said weld metal is characterized by ductility of 20-35 wt % elongation as compared to the original material 1 length; (ii) said weld metal is characterized by an averaged V-Charpy impact energy of 110 to 150 J at −30° C.; (iii) said weld metal comprises up to 0.3 wt % nickel; said weld metal comprises 0.001 to 0.3 wt % nickel; (v) said weld metal comprises up to 0.08 wt % ferro vanadium; (vi) said weld metal comprises up to 0.2 wt % chromium; (vii) weld metal comprises 0.20-0.22 wt % silicon; and any combination thereof.

47-52. (canceled)
